(19) United States
(12) Patent Application Publication
(10) Pub. No.: US 2026/0208789 A1
(43) Pub. Date: Jul. 23, 2026

(54) HILL PARKING SYSTEM

(71) Applicant: GM Global Technology Operations LLC, Detroit, MI (US)

(72) Inventors: Reza Zarringhalam, Whitby (CA); Milad Jalaliyazdi, Richmond Hill (CA); Ben MacCallum, Toronto (CA)

(21) Appl. No.: 19/027,149

(22) Filed: Jan. 17, 2025

(51) Int. Cl. B62D 6/00; B60W 30/18; B60W 50/14

(52) U.S. Cl. CPC B62D 6/002; B60W 30/18009; B60W 50/14; B60W 2510/1005; B60W 2520/04; B60W 2520/06; B60W 2552/15; B60W 2552/50; B60W 2554/801

(57) ABSTRACT

A system for automatically positioning steerable wheels of a vehicle parked on an inclined surface includes an automatic driving assistance system (ADAS) controller in communication with a plurality of sensors and adapted to determine that automatic positioning of the steerable wheels of the vehicle is appropriate, calculate a desired steering angle for the steerable wheels of the vehicle, actuate a steering rack motor, and position, with the steering rack motor, the steerable wheels of the vehicle at the desired steering angle.

### INTRODUCTION

The present disclosure relates to a system for automatically adjusting the steering angle of wheels of a vehicle when the vehicle is parked on an inclined roadway.

Drivers of vehicles are trained to angle the steering wheels relative to a curb and/or roadway edge when parking on an inclined road surface. While current vehicle systems achieve their intended purpose, there is a need for a new and improved system and method of automatically adjusting the angle of steerable wheels of a vehicle when the vehicle is parked on an inclined roadway.

### SUMMARY

According to several aspects of the present disclosure, a method of automatically positioning steerable wheels of a vehicle parked on an inclined surface includes determining, with an automatic driving assistance system (ADAS) controller in communication with a plurality of sensors within the vehicle, that automatic positioning of the steerable wheels of the vehicle is appropriate, calculating, with the ADAS controller, a desired steering angle for the steerable wheels of the vehicle, actuating, with the ADAS controller, a steering rack motor, and positioning, with the steering rack motor, the steerable wheels of the vehicle at the desired steering angle.

According to another aspect, the determining, with the ADAS controller in communication with the plurality of sensors within the vehicle, that automatic positioning of the steerable wheels of the vehicle is appropriate further includes receiving, with an enablement module of the ADAS controller, from a human machine interface (HMI) within the vehicle, preferences from an operator within the vehicle, and determining, with the ADAS controller, that automatic positioning of the steerable wheels of the vehicle is appropriate based on preferences of the operator.

According to another aspect, the determining, with the ADAS controller in communication with the plurality of sensors within the vehicle, that automatic positioning of the steerable wheels of the vehicle is appropriate further includes, when the ADAS controller has determined that automatic positioning of the steerable wheels of the vehicle is appropriate based on preferences of the operator, determining, with the ADAS controller, that the vehicle is parked by receiving, with a parking detection module within the ADAS controller, from a gear selector sensor within the vehicle, data related to a state of a transmission of the vehicle, receiving, with the parking detection module within the ADAS controller, from the plurality of sensors within the vehicle, data related to movement of the vehicle, and determining, with the parking detection module, that the vehicle is parked when the transmission is in park and the vehicle is stopped, and determining, with the ADAS controller, that automatic positioning of the steerable wheels of the vehicle is appropriate when the vehicle is parked.

According to another aspect, the determining, with the ADAS controller in communication with the plurality of sensors within the vehicle, that automatic positioning of the steerable wheels of the vehicle is appropriate further includes, when the ADAS controller has determined that automatic positioning of the steerable wheels of the vehicle is appropriate based on preferences of the operator and the vehicle is parked, receiving, with an environment module within the ADAS controller, from the plurality of sensors within the vehicle, data related to an incline angle of the roadway surface where the vehicle is parked, determining, with the environment module, if the incline angle of the roadway surface where the vehicle is parked is greater that a predetermined threshold, and determining, with the ADAS controller, that automatic positioning of the steerable wheels of the vehicle is appropriate when the incline angle of the roadway surface where the vehicle is parked is greater than the predetermined threshold.

According to another aspect, the determining, with the ADAS controller in communication with the plurality of sensors within the vehicle, that automatic positioning of the steerable wheels of the vehicle is appropriate further includes, when the ADAS controller has determined that automatic positioning of the steerable wheels of the vehicle is appropriate based on preferences of the operator, the vehicle is parked, and the incline angle of the roadway surface where the vehicle is parked is greater than the predetermined threshold, receiving, with the environment module, from the plurality of sensors within the vehicle, data related to a proximity of the vehicle to a road edge and/or curb, calculating, with the environment module, a distance between the vehicle and the road edge and/or curb, and determining, with the ADAS controller, that automatic positioning of the steerable wheels of the vehicle is appropriate when the distance between the vehicle and the road edge and/or curb is less than a predetermined threshold.

According to another aspect, after the ADAS controller determines that automatic positioning of the steerable wheels of the vehicle is appropriate, the calculating, with the ADAS controller, the desired steering angle for the steerable wheels of the vehicle further includes receiving, with the environment module, from the plurality of sensors within the vehicle, data related to presence of a curb in proximity of the vehicle, and when a curb is present, calculating, with the environmental module, with data from the plurality of sensors, a height of the curb.

According to another aspect, the calculating, with the ADAS controller, the desired steering angle for the steerable wheels of the vehicle further includes, when no curb is present, calculating, with a hill parking module of the ADAS controller, a desired roll-away trajectory based on a location of the vehicle relative to the road edge and calculating, with the hill parking module, the desired steering angle based on the desired roll-away trajectory, when the height of the curb is less than a pre-determined threshold, calculating, with the hill parking module, the roll-away trajectory and the desired steering angle the same as when no curb is present, and when the height of the curb is at least the pre-determined threshold, calculating, with the hill parking module, the desired roll-away trajectory based on a location of the vehicle relative to the curb and calculating the desired steering angle to bring the steerable wheels into contact with the curb.

According to another aspect, the positioning, with the steering rack motor, the steerable wheels of the vehicle at the desired steering angle further includes receiving, with the hill parking module, data from the plurality of sensors within the vehicle related to the steering angle of the steerable wheels of the vehicle, determining, with the hill parking module, if the steerable wheels of the vehicle have been moved to the desired steering angle, and when the steerable wheels of the vehicle have reached the desired steering angle, deactivating positioning of the steerable wheels of the vehicle, and displaying, with a communication module within the ADAS controller, via the HMI, a message indicating that the automatic positioning of the steerable wheels of the vehicle is complete.

According to another aspect, the positioning, with the steering rack motor, the steerable wheels of the vehicle at the desired steering angle further includes, when the steerable wheels of the vehicle have not yet reached the desired steering angle, receiving, with the hill parking module, data from a steering rack torque sensor related to an amount of torque being applied to the steerable wheels of the vehicle, determining, with the hill parking module, if the amount of torque being applied to the steerable wheels of the vehicle exceeds a pre-determined threshold, and when the amount of torque being applied to the steerable wheels of the vehicle exceeds the pre-determined threshold, deactivating positioning of the steerable wheels of the vehicle, and displaying, with the communication module, via the HMI, a message indicating that the automatic positioning of the steerable wheels of the vehicle has been cancelled.

According to another aspect, the positioning, with the steering rack motor, the steerable wheels of the vehicle at the desired steering angle further includes, when the steerable wheels of the vehicle have not yet reached the desired steering angle and the amount of torque being applied to the steerable wheels of the vehicle does not exceed the pre-determined threshold, receiving, with the hill parking module, data from a steering wheel torque sensor related to an amount of torque being applied to the steering wheel by an operator of the vehicle, determining, with the hill parking module, if the amount of torque being applied to the steering wheel exceeds a pre-determined threshold, and when the amount of torque being applied to the steering wheel exceeds the pre-determined threshold, deactivating positioning of the steerable wheels of the vehicle, and displaying, with the communication module, via the HMI, a message indicating that the automatic positioning of the steerable wheels of the vehicle has been cancelled.

According to another aspect, the positioning, with the steering rack motor, the steerable wheels of the vehicle at the desired steering angle further includes, when the steerable wheels of the vehicle have not yet reached the desired steering angle, the amount of torque being applied to the steerable wheels of the vehicle does not exceed the pre-determined threshold, and the amount of torque being applied to the steering wheel does not exceed the pre-determined threshold, receiving, with the hill parking module, data from the gear selector sensor, determining, with the hill parking module, if the vehicle has been shifted out of park, and when the vehicle has been shifted out of park, deactivating positioning of the steerable wheels of the vehicle and displaying, with the communication module, via the HMI, a message indicating that the automatic positioning of the steerable wheels of the vehicle has been cancelled.

According to another aspect, the calculating, with the ADAS controller, the desired steering angle for the steerable wheels of the vehicle further includes minimizing an object function presented as;

$$J = {\sum }_{k = 1}^{N} ‖ ( y - {y}_{des} ) ‖ \begin{matrix}2 \\ Q\end{matrix} + ‖ u - {u}_{des} ‖ \begin{matrix}2 \\ R\end{matrix} + ‖ u - {u}_{fn 1} ‖ \begin{matrix}2 \\ F\end{matrix} ,$$

u_{fnl} represents the desired steering angle.

According to several aspects of the present disclosure, a system for automatically positioning steerable wheels of a vehicle parked on an inclined surface includes an automatic driving assistance system (ADAS) controller in communication with a plurality of sensors and adapted to determine that automatic positioning of the steerable wheels of the vehicle is appropriate, calculate a desired steering angle for the steerable wheels of the vehicle, actuate a steering rack motor, and position, with the steering rack motor, the steerable wheels of the vehicle at the desired steering angle.

According to another aspect, when determining that automatic positioning of the steerable wheels of the vehicle is appropriate, the ADAS controller is further adapted to receive, with an enablement module of the ADAS controller, from a human machine interface (HMI) within the vehicle, preferences from an operator within the vehicle, and determine that automatic positioning of the steerable wheels of the vehicle is appropriate based on preferences of the operator.

According to another aspect, when the ADAS controller has determined that automatic positioning of the steerable wheels of the vehicle is appropriate based on preferences of the operator, the ADAS controller is further adapted to receive, with a parking detection module within the ADAS controller, from a gear selector sensor within the vehicle, data related to a state of a transmission of the vehicle, receive, with the parking detection module, from the plurality of sensors within the vehicle, data related to movement of the vehicle, determine, with the parking detection module, that the vehicle is parked when the transmission is in park and the vehicle is stopped, and determine that automatic positioning of the steerable wheels of the vehicle is appropriate when the vehicle is parked.

According to another aspect, when the ADAS controller has determined that automatic positioning of the steerable wheels of the vehicle is appropriate based on preferences of the operator and the vehicle is parked, the ADAS controller is further adapted to receive, with an environment module within the ADAS controller, from the plurality of sensors within the vehicle, data related to an incline angle of the roadway surface where the vehicle is parked, determine, with the environment module, if the incline angle of the roadway surface where the vehicle is parked is greater that a predetermined threshold, and determine that automatic positioning of the steerable wheels of the vehicle is appropriate when the incline angle of the roadway surface where the vehicle is parked is greater than the predetermined threshold.

According to another aspect, when the ADAS controller has determined that automatic positioning of the steerable wheels of the vehicle is appropriate based on preferences of the operator, the vehicle is parked, and the incline angle of the roadway surface where the vehicle is parked is greater than the predetermined threshold, the ADAS controller is further adapted to receive, with the environment module, from the plurality of sensors within the vehicle, data related to a proximity of the vehicle to a road edge and/or curb, calculate, with the environment module, a distance between the vehicle and the road edge and/or curb, and determine that automatic positioning of the steerable wheels of the vehicle is appropriate when the distance between the vehicle and the road edge and/or curb is less than a predetermined threshold.

According to another aspect, the ADAS controller is further adapted to one of, when no curb is present, calculate, with a hill parking module of the ADAS controller, a desired roll-away trajectory based on a location of the vehicle relative to the road edge and calculate, with the hill parking module, the desired steering angle based on the desired roll-away trajectory, when a curb is present and a height of the curb is less than a pre-determined threshold, calculate, with the hill parking module, the roll-away trajectory and the desired steering angle the same as when no curb is present, or when a curb is present and a height of the curb is at least the pre-determined threshold, calculate, with the hill parking module, the desired roll-away trajectory based on a location of the vehicle relative to the curb and calculating the desired steering angle to bring the steerable wheels into contact with the curb.

According to still another aspect, when positioning with the steering rack motor, the steerable wheels of the vehicle at the desired steering angle, the ADAS controller is further adapted to deactivate positioning of the steerable wheels of the vehicle and display, with a communication module within the ADAS controller, via the HMI, a message indicating that the automatic positioning of the steerable wheels of the vehicle is complete when the steering angle of the steerable wheels of the vehicle, measured by a steering angle sensor, reaches the desired steering angle, and deactivate positioning of the steerable wheels of the vehicle, and display, with the communication module, via the HMI, a message indicating that the automatic positioning of the steerable wheels of the vehicle has been cancelled when at least one of the steerable wheels of the vehicle have not yet reached the desired steering angle and an amount of torque being applied to the steerable wheels of the vehicle, measured by a steering rack torque sensor, exceeds a pre-determined threshold, the steerable wheels of the vehicle have not yet reached the desired steering angle, the amount of torque being applied to the steerable wheels of the vehicle does not exceed the pre-determined threshold, and an amount of torque being applied to the steering wheel by an operator within the vehicle, measured by a steering wheel torque sensor, exceeds a pre-determined threshold, and the steerable wheels of the vehicle have not yet reached the desired steering angle, the amount of torque being applied to the steerable wheels of the vehicle does not exceed the pre-determined threshold, the amount of torque being applied to the steering wheel does not exceed the pre-determined threshold, and the vehicle has been shifted out of park.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle having a system in accordance with an exemplary embodiment of the present disclosure;

FIG. 2 is a schematic illustration of the system according to an exemplary embodiment;

FIG. 3A is a schematic illustration of a vehicle parked facing upward on an inclined roadway;

FIG. 3B is a schematic illustration of a vehicle parked facing downward on an inclined roadway;

FIG. 4A is a schematic top view of a vehicle parked facing upward on an inclined roadway adjacent a road edge;

FIG. 4B is a schematic top view of a vehicle parked facing upward on an inclined roadway adjacent a curb;

FIG. 5A is a schematic top view of a vehicle parked facing downward on an inclined roadway adjacent a road edge;

FIG. 5B is a schematic top view of a vehicle parked facing downward on an inclined roadway adjacent a curb;

FIG. 6A is a schematic top view of a vehicle equipped with four-wheel steering parked facing upward on an inclined roadway adjacent a curb;

FIG. 6B is a schematic top view of a vehicle equipped with four-wheel steering parked facing downward on an inclined roadway adjacent a road edge;

FIG. 7 is a illustration of a human machine interface display presenting options for an operator related to operation of the system;

FIG. 8 is an example message displayed on the human machine interface and adapted to inform an occupant within the vehicle that the system is active;

FIG. 9 is an example message displayed on the human machine interface and adapted to inform the occupant within the vehicle that automatic positioning of the steerable wheels is complete;

FIG. 10A is an example message displayed on the human machine interface and adapted to inform the occupant within the vehicle that the system has been disabled because the torque applied to the steerable wheels exceed a pre-determined threshold;

FIG. 10B is an example message displayed on the human machine interface and adapted to inform the occupant within the vehicle that the system has been disabled because the torque applied to the steering wheel by the operator exceeds a pre-determined threshold;

FIG. 10C is an example message displayed on the human machine interface and adapted to inform the occupant within the vehicle that the system has been disabled because the transmission of the vehicle has been shifted out of park;

FIG. 11 is a schematic illustration of a vehicle being parked automatically with a parking assist system;

FIG. 12, is a graph illustrating the smooth transition of the steering angle to the desired steering angle; and

FIG. 13 is a schematic flowchart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, including autonomous or semi-autonomous vehicles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances (widths, heights, lengths), comprises plus/minus 10%. In addition, disclosure of ranges includes disclosure of all values and further divided ranges within the entire range, including endpoints and sub-ranges given for the ranges. In addition, disclosure of ranges includes disclosure of all values and further divided ranges within the entire range, including endpoints and sub-ranges given for the ranges.

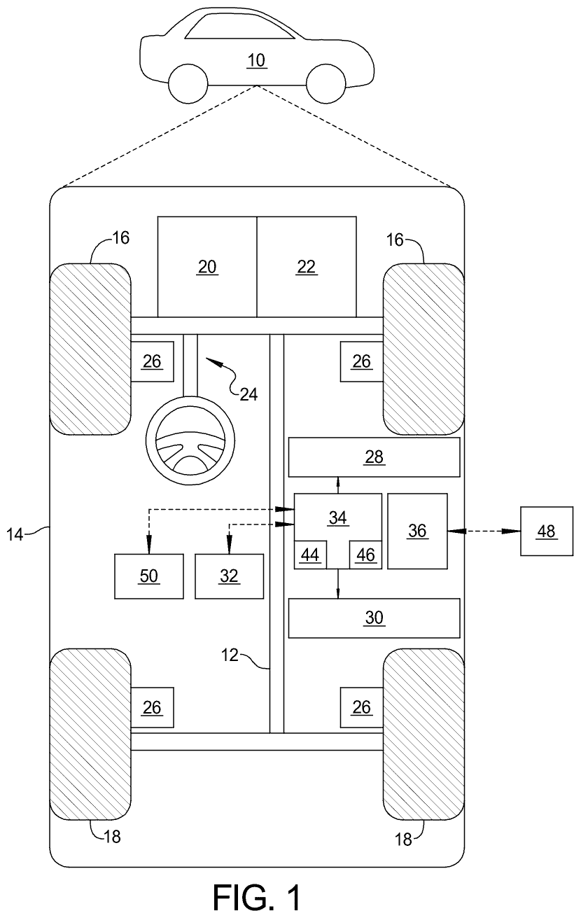

In accordance with an exemplary embodiment, FIG. 1 shows a vehicle 10 with an associated system 50 for automatically positioning steerable wheels of the vehicle when the vehicle is parked. In general, the system 11 works in conjunction with other systems within the vehicle 10 to display various information and infotainment content for the driver. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 50 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The system 50 can be utilized to provide automatic positioning of the steerable wheels 16, 18 when the autonomous vehicle 10 completes a parking maneuver. The novel aspects of the present disclosure are also applicable to non-autonomous vehicles, wherein the system 50 provides automatic positioning of the steerable wheels after the vehicle 10 has been manually parked by an operator.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the steerable wheels (front wheels 16 and/or rear wheels 18). The steerable wheels may include only the front wheels 16, such as is most common in automotive vehicles 10, however, the steerable wheels may include both the front wheels 16 and the rear wheels 18, such as with a vehicle equipped with all-wheel steering. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10.

In a non-limiting example wherein the plurality of sensing devices 40a-40n includes a camera, the plurality of sensing devices 40a-40n measures distances using an image processing algorithm configured to process images from the camera and determine distances between objects. In another non-limiting example, the plurality of vehicle sensors 40a-40n includes a stereoscopic camera having distance measurement capabilities. In one example, at least one of the plurality of sensing devices 40a-40n is affixed inside of the vehicle 10, for example, in a headliner of the vehicle 10, having a view through the windshield of the vehicle 10. In another example, at least one of the plurality of sensing devices 40a-40n is a camera affixed outside of the vehicle 10, for example, on a roof of the vehicle 10, having a view of the environment surrounding the vehicle 10 and adapted to collect information (images) related to the environment outside the vehicle 10. It should be understood that various additional types of sensing devices, such as, for example, LiDAR sensors, ultrasonic ranging sensors, radar sensors, and/or time-of-flight sensors are within the scope of the present disclosure. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the vehicle controller 34 are embodied in a trajectory planning system and, when executed by the at least one data processor 44, generates a trajectory output that addresses kinematic and dynamic constraints of the environment. For example, the instructions receive as input process sensor and map data. The instructions perform a graph-based approach with a customized cost function to handle different road scenarios in both urban and highway roads.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

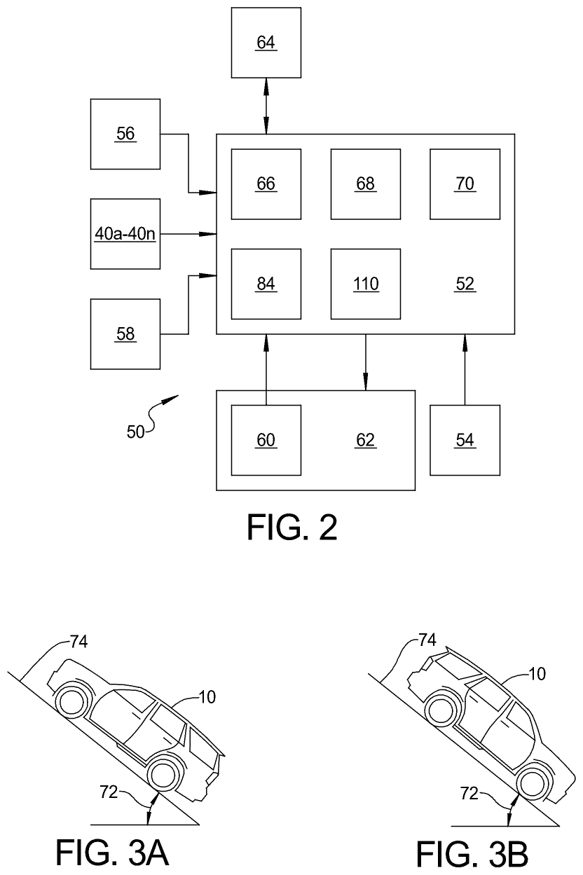

Referring to FIG. 2 a schematic diagram of the system 50 is shown. The system 50 includes an automatic driving assistance system (ADAS) controller 52, in communication with the vehicle controller 34 and in communication with the plurality of sensing devices (onboard sensors) 40a-40n. The ADAS controller 52 is adapted to control autonomous aspects of the vehicle, including, autonomous positioning of the steerable wheels 16, 18 of the vehicle 10 during operation, and, per aspects of the present disclosure, after the vehicle 10 has been parked. The plurality of onboard sensors 40a-40n are adapted to detect and monitor vehicle driving characteristics and the environment surrounding the vehicle 10. Specifically, the plurality of sensing devices 40a-40n includes a steering angle sensor 54 adapted to measure the angle of the steerable wheels 16, 18 relative to the vehicle 10, a gear shifter sensor 56 adapted to monitor which gear (forward gears, reverse, park) the transmission system 22 is in, a steering wheel torque sensor 58 adapted to measure any torque input to the steering wheel of the vehicle by an operator therein, and a steering rack torque sensor 60 adapted to measure the torque applied to a steering rack of the vehicle 10 when a steering rack motor 62 positions the steerable wheels 16, 18 of the vehicle 10.

The ADAS controller 52 may be the vehicle controller 34, or the ADAS controller 52 may be a separate controller in communication with the vehicle controller 34. In addition to the plurality of onboard sensors 40a-40n, the ADAS controller 52 is in communication with a human machine interface (HMI) 64. The HMI is adapted to provide visual and audible information to occupants within the vehicle 10, and is adapted to allow an occupant within the vehicle 10 to input information to the ADAS controller 52. In an exemplary embodiment, the HMI 64 includes a touch screen display adapted to display images and video and to allow a passenger to input information to the system 50 by touching the touch screen display, a microphone adapted to receive verbal input from the passengers, and a speaker adapted to provide audio output for the passengers.

The ADAS controller 52 is further in communication with the wireless communication module 36. The wireless communication module 36 is located within the vehicle controller 34 and is adapted to allow wireless communication between the vehicle 10 and other vehicles or other external sources. The ADAS controller 52 is adapted to collect information from databases via a wireless data communication network over wireless communication channels such as a WLAN, 4G/LTE or 5G network, or the like. Such databases can be communicated with directly via the internet, or may be cloud-based databases. Information that may be collected by the ADAS controller 52 from such external sources 48 includes, but is not limited to road and highway databases maintained by the department of transportation, a global positioning system, the internet, other vehicles via V2V communication networks, traffic information sources, vehicle-based support systems such as OnStar, etc.

In an exemplary embodiment, the ADAS controller 52 is adapted to determine that automatic positioning of the steerable wheels 16, 18 of the vehicle 10 is appropriate, calculate a desired steering angle for the steerable wheels 16, 18 of the vehicle 10, actuate the steering rack motor 62, and position, with the steering rack motor 62, the steerable wheels 16, 18 of the vehicle 10 at the desired steering angle. When a vehicle 10 is parked on an inclined surface, the vehicle 10 may roll into traffic if there is a failure of components within the vehicle 10 such as parking brake, transmission, etc. Thus, it is common practice for drivers of vehicles to position the steerable wheels 16, 18 of a vehicle 10 in a specific manner when parking the vehicle 10 on a hill where the vehicle 10 is facing up-hill, as shown in FIG. 3A, or facing down-hill, as shown in FIG. 3B. Thus, the ADAS controller 52 of the present disclosure is adapted to automatically position the steerable wheels 16, 18 to minimize risk of the vehicle 10 rolling into the roadway when conditions are such that the ADAS controller 52 determines that automatic positioning of the steerable wheels 16, 18 is appropriate.

In an exemplary embodiment, a first step in determining that automatic positioning of the steerable wheels 16, 18 of the vehicle is appropriate is determining preferences of an operator within the vehicle 10. For example, the current driver of the vehicle 10 may not want the system 50 to automatically position the steerable wheels 16, 18 of the vehicle 10. Thus, when determining that automatic positioning of the steerable wheels 16, 18 of the vehicle 10 is appropriate, the ADAS controller 52 is further adapted to receive, with an enablement module 66 of the ADAS controller 52, from the HMI 64 within the vehicle 10, preferences from an operator within the vehicle 10, and determine that automatic positioning of the steerable wheels 16, 18 of the vehicle 10 is appropriate based on preferences of the operator. For example, if the operator uses the HMI 64 to communicate a preference not to automatically position the steerable wheels 16, 18, then the ADAS controller 52 will determine that automatic positioning of the steerable wheels 16, 18 is not appropriate. If, however, the operator uses the HMI 64 to communicate a preference to allow automatic positioning of the steerable wheels 16, 18, then the ADAS controller 52 will determine that automatic positioning of the steerable wheels 16, 18 is appropriate based on operator preferences. The enablement module 66 is adapted to monitor preferences input via the HMI 64, including turning the system 50 “on” or “off” to determine if automatic positioning of the steerable wheels 16, 18 is appropriate.

Referring to FIG. 7, a selection screen is displayed on the HMI 64. As shown, the selections screen provides option for the occupant within the vehicle 10 to either turn the system 50 off, select an option wherein the system 50 will only provide alerts to the occupant suggesting that positioning of the steerable wheels 16, 18 may be appropriate and the occupant within the vehicle 10 can either elect to position the steerable wheels 16, 18 as suggested or not. Finally, the operator of the vehicle can select an option wherein the system 50 will both provide alerts to the occupant and automatically initiate positioning of the steerable wheels 16, 18 when appropriate. The display may include graphics adapted to provide additional information to the occupant. As shown, the display screen of the HMI 64 provides a graphic illustrating a representation of the vehicle 10 shown facing upward on an inclined roadway surface and a graphic illustration of the steering wheel providing visual indication of the steering angle.

In another exemplary embodiment, when the ADAS controller 52 has determined that automatic positioning of the steerable wheels 16, 18 of the vehicle 10 is appropriate based on preferences of the operator, a second step in determining that automatic positioning of the steerable wheels 16, 18 of the vehicle 10 is appropriate involves determination that the vehicle 10 is in park. The ADAS controller 52 is further adapted to receive, with a parking detection module 68 within the ADAS controller 52, from the gear selector sensor 56 and other ones of the plurality of sensors 40a-40n within the vehicle 10, data related to a state of a transmission system 22 of the vehicle and data related to movement of the vehicle 10. If the vehicle 10 is not moving, and the transmission system 22 is in park, the parking detection module 68 will determine that the vehicle 10 is parked, and the ADAS controller 52 will determine that automatic positioning of the steerable wheels 16, 18 of the vehicle 10 is appropriate.

In another exemplary embodiment, when the ADAS controller 52 has determined that automatic positioning of the steerable wheels 16, 18 of the vehicle 10 is appropriate based on preferences of the operator and the vehicle 10 is parked, a third step in determining that automatic positioning of the steerable wheels 16, 18 of the vehicle 10 is appropriate involves verifying that the vehicle 10 is indeed parked on an inclined surface. The ADAS controller 52 is further adapted to receive, with an environment module 70 within the ADAS controller 52, from the plurality of sensors 40a-40n within the vehicle 10, data related to an incline angle 72 of the roadway surface 74 where the vehicle 10 is parked. The environment module 70 determines if the incline angle 72 of the roadway surface 74 where the vehicle 10 is parked is greater than a predetermined threshold, and determines that automatic positioning of the steerable wheels 16, 18 of the vehicle 10 is appropriate when the incline angle 72 of the roadway surface 74 where the vehicle 10 is parked is greater than the predetermined threshold. The incline angle 72 is an indication of the grade of the inclined surface. In an exemplary embodiment, for the ADAS controller 52 to determine that automatic positioning of the steerable wheels 16, 18 is appropriate is about 2%, thus, the predetermined threshold for the incline angle 72 is about 1-2 degrees.

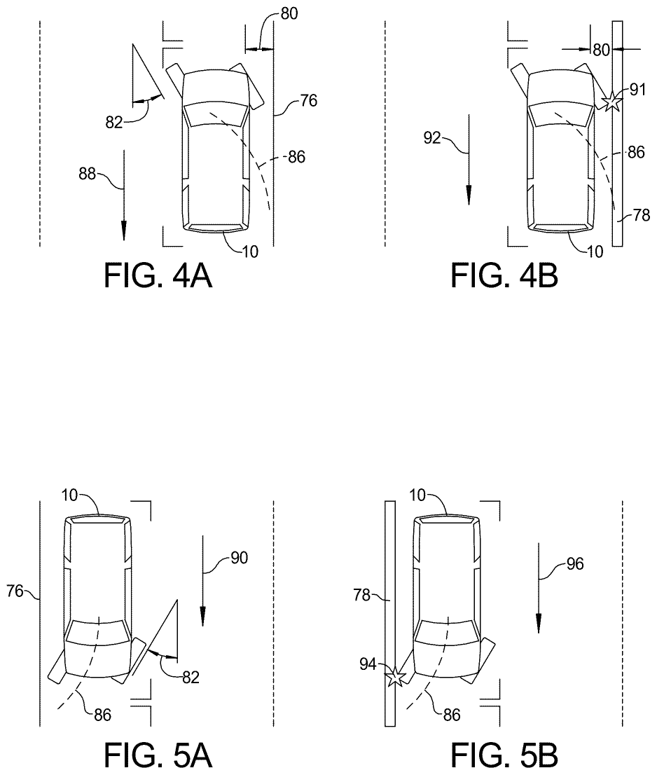

In another exemplary embodiment, when the ADAS controller 52 has determined that automatic positioning of the steerable wheels 16, 18 of the vehicle 10 is appropriate based on preferences of the operator, the vehicle 10 is parked, and the incline angle 72 of the roadway surface 74 where the vehicle 10 is parked is greater than the predetermined threshold, the ADAS controller 52 is further adapted to receive, with the environment module 70, from the plurality of sensors 40a-40n within the vehicle 10, data related to a proximity of the vehicle 10 to a road edge 76 and/or curb 78. Referring to FIG. 4A and FIG. 4B, the ADAS controller 52 then calculates, with the environment module 70, a distance 80 between the vehicle 10 and the road edge 76 and/or curb 78, and determines that automatic positioning of the steerable wheels 16, 18 of the vehicle 10 is appropriate when the distance 80 between the vehicle 10 and the road edge 76 and/or curb 78 is less than a predetermined threshold.

The predetermined threshold for the distance 80 between the vehicle 10 and the road edge 76 and/or curb 78 is established to prevent actuation of automatic positioning of the steerable wheels 16, 18 of the vehicle 10 when the vehicle 10 is not parked at a road edge. For example, if a vehicle 10 stops in a lane of a roadway due to heavy traffic, and the operator of the vehicle 10 places the transmission of the vehicle 10 in park temporarily, it would be inconvenient for the operator if the steerable wheels 16, 18 have been automatically positioned at an angle. When the heavy traffic subsides, and the operator of the vehicle 10 shifts the vehicle into drive, the operator will expect the vehicle 10 to begin moving forward, and would have to rapidly adjust the steering angle of the steerable wheels 16, 18 if the steerable wheels 16, 18 have been automatically positioned at an angle. Thus, automatic positioning of the steerable wheels 16, 18 of the vehicle 10 is not deemed, by the ADAS controller 52 to be appropriate, unless all other conditions have been satisfied, and, the distance 80 between the vehicle 10 and the road edge 76 and/or curb 78 is less than the predetermined threshold for such distance 80.

Once the ADAS controller 52 has determined that automatic positioning of the steerable wheels 16, 18 of the vehicle 10 is appropriate, the ADAS controller 52 then calculates a desired steering angle 82 for the steerable wheels 16, 18 of the vehicle 10. Referring to FIG. 4A and FIG. 5A, when no curb 78 is present, the ADAS controller 52 calculates, with a hill parking module 84 of the ADAS controller 52, a desired roll-away trajectory 86 based on a location of the vehicle 10 relative to the road edge 76 and calculates, with the hill parking module 84, the desired steering angle 82 based on the desired roll-away trajectory 86. As shown in FIG. 4A, when the vehicle 10 is parked facing uphill, the desired roll-away trajectory 86 is adapted to direct the front wheels 16 toward the road edge 76 if the vehicle 10 rolls down hill as indicated by arrow 88. As shown in FIG. 5A, when the vehicle 10 is parked facing downhill, the desired roll-away trajectory 86 is adapted to direct the front wheels 16 toward the road edge 76 if the vehicle 10 rolls downhill as indicated by arrow 90.

When a curb 78 is present and a height of the curb 78 is less than a pre-determined threshold, the ADAS controller 52 calculates, with the hill parking module 84, the desired roll-away trajectory 86 and the desired steering angle 82 the same as when no curb 78 is present. The predetermined threshold for the height of the curb 78 is established to prevent consideration of the curb 78 when the curb 78 is low enough that a wheel 16, 18 of the vehicle 10 could easily roll over the curb 78 during a roll-away event. In such circumstances, the curb 78 would not stop continued rolling of the vehicle 10, and thus, the ADAS controller 52 treats a curb 78 that is less than the predetermined threshold the same as a road edge 76, when no curb 78 is present. For example, a very low curb 78, such as a curb 78 that is only one or two inches high, would not provide a stop for wheels 16, 18 of the vehicle 10, but a curb 78 that is four inches high or more would provide a stop to prevent continued motion of the vehicle 10 during a roll-away event. Thus, by way of non-limiting example, the predetermined threshold for the height of the curb would be four inches.

Referring to FIG. 4B and FIG. 5B, when a curb 78 is present and a height of the curb 78 is at least the pre-determined threshold, the ADAS controller 52 calculates, with the hill parking module 84, the desired roll-away trajectory 86 based on a location of the vehicle 10 relative to the curb 78 and calculates the desired steering angle 82 to bring the steerable wheels 16, 18 into contact with the curb 78. The predetermined threshold for the height of the curb 78 is established to prevent consideration of the curb 78 when the curb 78 is low enough that a wheel 16, 18 of the vehicle 10 could easily roll over the curb 78 during a roll-away event. When the curb 78 is high enough to provide a positive stop, against which the wheels 16, 18 of the vehicle 10 are likely unable to roll over during a roll-away event, the ADAS controller 52 calculates the desired steering angle 82 to bring the steerable wheels 16, 18 into contact with the curb 78, wherein the curb 78 will allow minimal movement of the vehicle during a roll-away event. The pre-determined threshold for the height of the curb 78 may be adjustable or tunable according to past occurrences, using machine learning. For example, if the ADAS controller 52 detects a curb 78 that exceeds the pre-determined threshold for the height of the curb 78, and during a roll-away event the steerable wheels 16, 18 of the vehicle 10 roll over the curb 78, the ADAS controller, using machine learning algorithms and techniques, “learns” from the occurrence and increases the pre-determined threshold for the height of the curb 78. In addition, the pre-determined threshold for the height of the curb 78 may be adjusted or tuned according to preferences of an occupant within the vehicle 10.

As shown in FIG. 4B, when the vehicle 10 is parked facing uphill, the desired roll-away trajectory 86 is adapted to direct the front wheels 16 into a left turn bringing a backside of the right front wheel into contact with the curb 78, indicated at point 91, wherein the curb 78 will allow minimal or no movement of the vehicle 10 along the desired roll-away trajectory 86 if the vehicle 10 rolls downhill as indicated by arrow 92. As shown in FIG. 5B, when the vehicle 10 is parked facing downhill, the desired roll-away trajectory 86 is adapted to direct the front wheels 16 into a right turn bringing a frontside of the right front wheel 16 into contact with the curb 78, indicated at point 94, wherein the curb 78 will allow minimal or no movement of the vehicle 10 along the desired roll-away trajectory 86 if the vehicle 10 rolls downhill as indicated by arrow 96.

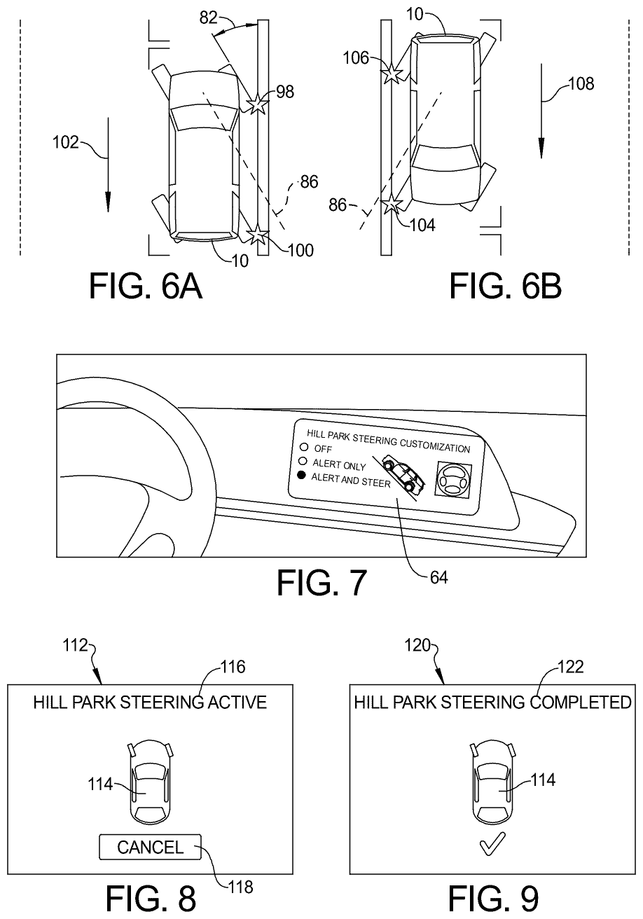

Referring to FIG. 6A and FIG. 6B, wherein the vehicle 10 is equipped with four-wheel steering, where both the front wheels 16 and the rear wheels 18 are adapted to steer the vehicle 10. As shown in FIG. 6A, when the vehicle 10 is parked facing uphill, the desired roll-away trajectory 86 is adapted to direct both the front wheels 16 and the rear wheels 18 into a left turn bringing a backside of the right front wheel 16 into contact with the curb 78, indicated at point 98 and bringing a backside of the right rear wheel 18 into contact with the curb 78, indicated at point 100, wherein the curb 78 will allow minimal or no movement of the vehicle 10 along the desired roll-away trajectory 86 if the vehicle 10 rolls downhill as indicated by arrow 102. As shown in FIG. 6B, when the vehicle 10 is parked facing downhill, the desired roll-away trajectory 86 is adapted to direct both the front wheels 16 and the rear wheels 18 into a right turn bringing a frontside of the right front wheel 16 into contact with the curb 78, indicated at point 104 and bringing a frontside of the right rear wheel 18 into contact with the curb 78, indicated at point 106, wherein the curb 78 will allow minimal or no movement of the vehicle 10 along the desired roll-away trajectory 86 if the vehicle 10 rolls downhill as indicated by arrow 108.

Once the ADAS controller 52 determines that positioning of the steerable wheels 16, 18 of the vehicle 10 is appropriate and calculates the desired steering angle 82, the ADAS controller 52 is adapted to proceed with actuating a steering rack motor 62 to move the steerable wheels 16, 18 and position the steerable wheels 16, 18 of the vehicle 10 at the desired steering angle 82.

Referring to FIG. 8, when positioning, with the steering rack motor 62, the steerable wheels 16, 18 of the vehicle 10 at the desired steering angle 82, the ADAS controller 52 is further adapted to display, with a communication module 110, a message 112 on the HMI 64 informing the occupant within the vehicle 10 that the system 50 is active and working to position the steerable wheels 16, 18. As shown, the message 112 includes a graphical representation 114 of the vehicle 10, and a textual message “Hill Park Steering Active” 116 indicating that the system 50 is active. The steerable front wheels 16 of the graphical representation 112 of the vehicle 10 may be shown with color, such as RED, indicating that the positioning of the steerable wheels 16 is in progress and not complete. The message 112 may further include a touchable icon 118 allowing the occupant within the vehicle 10 to selectively deactivate automatic positioning of the steerable wheels 16, 18 of the vehicle 10 before the steerable wheels 16, 18 of the vehicle 10 reach the desired steering angle 82.

When the steering angle 82 of the steerable wheels 16, 18 of the vehicle 10, measured by the steering angle sensor 54, reaches the desired steering angle 82, the ADAS controller 52 is further adapted to deactivate positioning of the steerable wheels 16, 18 of the vehicle 10 and display, with the communication module 110 within the ADAS controller 52, via the HMI 64, a message 120 indicating that the automatic positioning of the steerable wheels 16, 18 of the vehicle 10 is complete. Referring to FIG. 9, the message 120 includes the graphical representation 114 of the vehicle 10, wherein the steerable front wheels 16 are shown in GREEN and including a GREEN checkmark, to give a visual indication to the occupant that positioning of the steerable front wheels 16 is complete, and textual language “Hill Park Steering Completed” 122 indicating that the positioning of the steerable wheels 16, 18 of the vehicle 10 is complete.

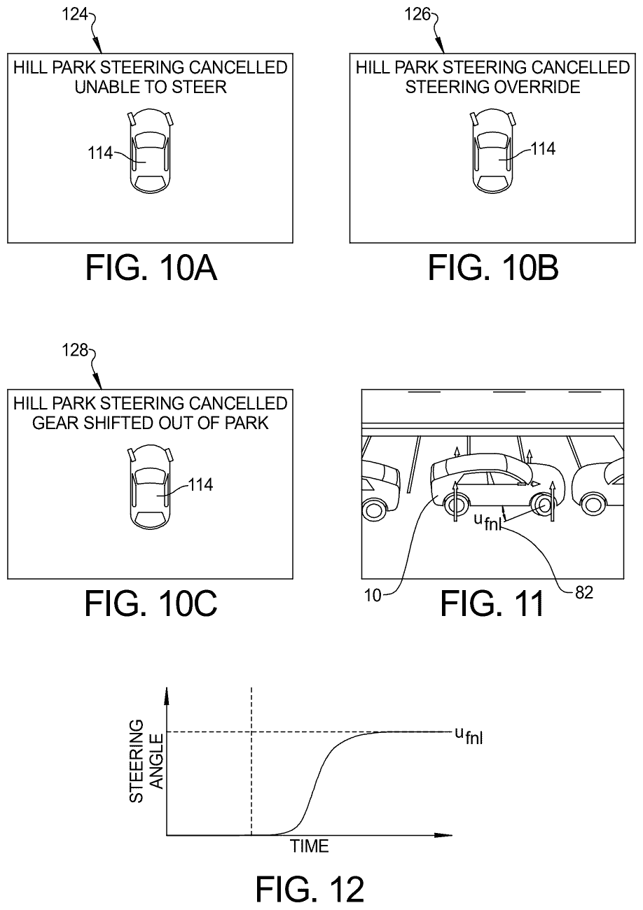

Referring to FIG. 10A, when positioning, with the steering rack motor 62, the steerable wheels 16, 18 of the vehicle 10 at the desired steering angle 82, the ADAS controller 52 is further adapted to deactivate positioning of the steerable wheels 16, 18 of the vehicle 10, and display, with the communication module 110, a message 124 on the HMI 64 informing the occupant within the vehicle 10 that the automatic positioning of the steerable wheels 16, 18 of the vehicle 10 has been cancelled when the steerable wheels 16, 18 of the vehicle 10 have not yet reached the desired steering angle 82 and an amount of torque being applied to the steerable wheels 16, 18 of the vehicle 10, measured by the steering rack torque sensor 60, exceeds a pre-determined threshold.

As the steering rack motor 62 moves the steerable wheels 16, 18 of the vehicle, the steering rack torque sensor 60 monitors the amount of force necessary to move the steerable wheels 16, 18. A spike in the amount of torque required to move the steerable wheels 16, 18 indicates that something is interfering with movement of the steerable wheels 16, 18. For example, one or both of the steerable wheels may have come into contact with an object or a curb. Continued application of force, by the steering rack motor 62, onto the steerable wheels 16, 18 may result in damage to the steerable wheels 16, 18, the steering rack motor 62, or other components of the steering system. Thus, during movement of the steerable wheels 16, 18, a feedback loop provides detection of a spike in the torque applied to the steerable wheels 16, 18, by the steering rack torque sensor 60, causing the ADAS controller 52 to cancel automatic positioning of the steerable wheels 16, 18 and display of a message 124 on the HMI informing the occupant and providing an explanation. The pre-determined threshold for the torque applied to the steerable wheels 16, 18 by the steering rack motor 62 is determined based on structural limitations of the components of the steering system 24 and components of the system 50 to ensure that the system 50 is deactivated before damage to any components of the steering system 24 or system 50 occurs.

As shown in FIG. 10A, the message 124 includes text “Hill Park Steering Cancelled” and “Unable to Steer”, informing the occupant that the system 50 has been deactivated because something is interfering with movement of the steerable wheels 16, 18. Further, the message 124 includes the graphic 114 of the vehicle 10, wherein the steerable front and or rear wheels 16, 18 of the vehicle 10 are shown in COLOR to indicate the nature of the reason for deactivation of the system 50. For example, the front wheels 16 of the graphic 114 of the vehicle 10 may be shown in BLACK. The color used to depict this situation may be customized by the occupant to their preferences.

Referring to FIG. 10B, when positioning, with the steering rack motor 62, the steerable wheels 16, 18 of the vehicle 10 at the desired steering angle 82, the ADAS controller 52 is further adapted to deactivate positioning of the steerable wheels 16, 18 of the vehicle 10, and display, with the communication module 110, a message 126 on the HMI 64 informing the occupant within the vehicle 10 that the automatic positioning of the steerable wheels 16, 18 of the vehicle 10 has been cancelled when the steerable wheels 16, 18 of the vehicle 10 have not yet reached the desired steering angle 82, the amount of torque being applied to the steerable wheels 16, 18 of the vehicle 10 does not exceed the pre-determined threshold, and an amount of torque being applied to a steering wheel by an operator within the vehicle 10, measured by the steering wheel torque sensor 58, exceeds a pre-determined threshold.

During automatic movement of the steerable wheels 16, 18 to the desired steering angle 82, components of the steering system 24 are automatically actuated by the ADAS controller 52. If, during automatic positioning of the steerable wheels 16, 18 an occupant within the vehicle 10 attempts to manually move the steerable wheels 16, 18 via input through the steering wheel, the steering wheel torque sensor 58 will measure the amount of torque applied to the steering wheel by the operator, and deactivate the system 50 when the occupant applies more than the predetermined about of torque to the steering wheel. The predetermined threshold of torque applied to the steering wheel is determined based on structural limitations of the components of the steering system 24 and components of the system 50 to ensure that the system 50 is deactivated before damage to any components of the steering system 24 or system 50 occurs when an operator within the vehicle attempts to move the steerable wheels 16, 18 in opposition to automatic movement of the steerable wheels 16, 18 to the desired steering angle 82.

As shown in FIG. 10B, the message 126 includes text “Hill Park Steering Cancelled” and “Steering Override”, informing the occupant that the system 50 has been deactivated because torque has been applied to the steering system 24 by an occupant within the vehicle 10. Further, the message 126 includes the graphic 114 of the vehicle 10, wherein the steerable front and or rear wheels 16, 18 of the vehicle 10 are shown in COLOR to indicate the nature of the reason for deactivation of the system 50. For example, the front wheels 16 of the graphic 114 of the vehicle 10 may be shown in BLACK. The color used to depict this situation may be customized by the occupant to their preferences.

Referring to FIG. 10C, when positioning, with the steering rack motor 62, the steerable wheels 16, 18 of the vehicle 10 at the desired steering angle 82, the ADAS controller 52 is further adapted to deactivate positioning of the steerable wheels 16, 18 of the vehicle 10, and display, with the communication module 110, a message 128 on the HMI 64 informing the occupant within the vehicle 10 that the automatic positioning of the steerable wheels 16, 18 of the vehicle 10 has been cancelled when the steerable wheels 16, 18 of the vehicle 10 have not yet reached the desired steering angle 82, the amount of torque being applied to the steerable wheels 16, 18 of the vehicle 10 does not exceed the pre-determined threshold, the amount of torque being applied to the steering wheel does not exceed the pre-determined threshold, and the vehicle 10 has been shifted out of park.

During automatic movement of the steerable wheels 16, 18 to the desired steering angle 82, components of the steering system 24 are automatically actuated by the ADAS controller 52. If, during automatic positioning of the steerable wheels 16, 18 the vehicle 10 is shifted from park, as detected by the gear shifter sensor 56, the vehicle may begin to move deliberately under control of an occupant within the vehicle 10, wherein, control of movement of the steerable wheels 16, 18 is given back to the operator within the vehicle 10.

As shown in FIG. 10C, the message 128 includes text “Hill Park Steering Cancelled” and “Gear Shifted Out of Park”, informing the occupant that the system 50 has been deactivated because the vehicle has been shifted out of Park. Further, the message 128 includes the graphic 114 of the vehicle 10, wherein the steerable front and or rear wheels 16, 18 of the vehicle 10 are shown in COLOR to indicate the nature of the reason for deactivation of the system 50. For example, the front wheels 16 of the graphic 114 of the vehicle 10 may be shown in BLACK. The color used to depict this situation may be customized by the occupant to their preferences.

In an exemplary embodiment, the calculating, with the ADAS controller, the desired steering angle 82 for the steerable wheels 16, 18 of the vehicle 10 further includes minimizing an object function presented as:

$$J = {\sum }_{k = 1}^{N} ‖ ( y - {y}_{des} ) ‖ \begin{matrix}2 \\ Q\end{matrix} + ‖ u - {u}_{des} ‖ \begin{matrix}2 \\ R\end{matrix} + ‖ u - {u}_{fn 1} ‖ \begin{matrix}2 \\ F\end{matrix}$$

Wherein, u_{fnl} presents the desired steering angle 82.

Thus, referring to FIG. 11 and FIG. 12, when the ADAS system controller 52 is used for automatic parking of the vehicle 10, the desired steering angle 82 is calculated, weights are gradually adapted at end of maneuver for a smooth transition to the desired steering angle 82, as shown in the graph of FIG. 12.

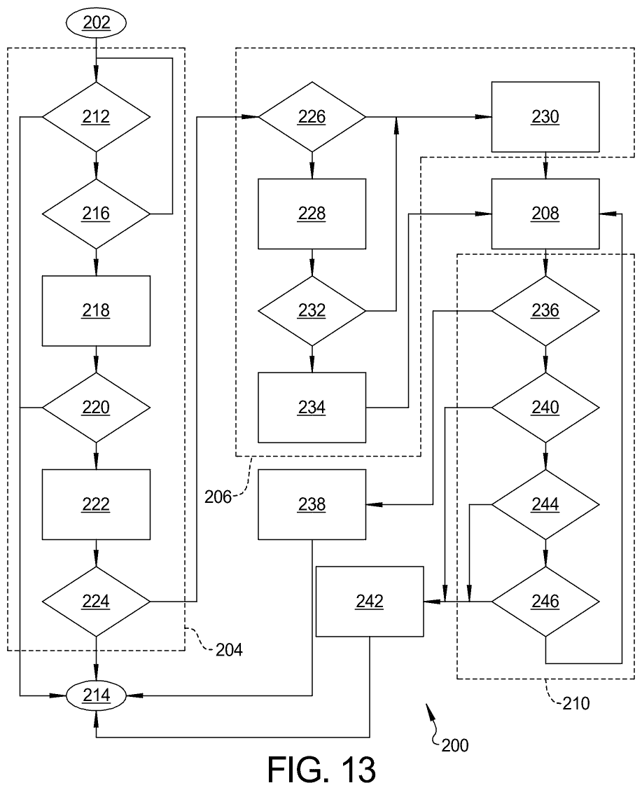

Referring to FIG. 13, a method 200 of automatically positioning steerable wheels 16, 18 of a vehicle 10 parked on an inclined surface includes, beginning at block 202, and moving to block 204, determining, with an automatic driving assistance system (ADAS) controller 52 in communication with a plurality of sensors 40a-40n within the vehicle 10, that automatic positioning of the steerable wheels 16, 18 of the vehicle 10 is appropriate, moving to block 206, calculating, with the ADAS controller 52, a desired steering angle 82 for the steerable wheels 16, 18 of the vehicle 10, moving to block 208, actuating, with the ADAS controller 52, a steering rack motor 62, and, moving to block 210, positioning, with the steering rack motor 62, the steerable wheels 16, 18 of the vehicle 10 at the desired steering angle 82.

In an exemplary embodiment, the determining, with the ADAS controller 52 in communication with the plurality of sensors 40a-40n within the vehicle 10, that automatic positioning of the steerable wheels 16, 18 of the vehicle 10 is appropriate at block 204 further includes, moving to block 212, receiving, with an enablement module 66 of the ADAS controller 52, from a human machine interface (HMI) 64 within the vehicle 10, preferences from an operator within the vehicle 10, and determining, with the ADAS controller 52, that automatic positioning of the steerable wheels 16, 18 of the vehicle 10 is appropriate based on preferences of the operator. Preferences of the operator include when the system should operate and how to operate. Referring again to FIG. 7, a selection screen displayed on the HMI 64 allows the operator to either turn the system 50 off, select an option wherein the system 50 will only provide alerts to the occupant, and select an option wherein the system 50 will both provide alerts to the occupant and automatically initiate positioning of the steerable wheels 16, 18 when appropriate. If driver preferences indicate that that automatic positioning of the steerable wheels 16, 18 of the vehicle 10 is not appropriate, then the method 200 moves from block 212 to block 214, wherein the method ends.

In another exemplary embodiment, the determining, with the ADAS controller 52 in communication with the plurality of sensors 40a-40n within the vehicle 10, that automatic positioning of the steerable wheels 16, 18 of the vehicle 10 is appropriate at block 204 further includes, when the ADAS controller 52 has determined that automatic positioning of the steerable wheels 16, 18 of the vehicle 10 is appropriate based on preferences of the operator at block 212, moving to block 216, determining, with the ADAS controller, that the vehicle is parked by receiving, with a parking detection module 68 within the ADAS controller 52, from a gear selector sensor 56 within the vehicle 10, data related to a state of a transmission 22 of the vehicle 10, receiving, with the parking detection module 68 within the ADAS controller 52, from the plurality of sensors 40a-40n within the vehicle 10, data related to movement of the vehicle 10, and, determining, with the parking detection module 68, that the vehicle 10 is parked when the transmission 22 is in park and the vehicle 10 is stopped, and, determining, with the ADAS controller 52, that automatic positioning of the steerable wheels 16, 18 of the vehicle 10 is appropriate when the vehicle 10 is parked. If, at block 216, the ADAS controller 52 determines that automatic position of the steerable wheels 16, 18 is not appropriate because the vehicle 10 is not parked, then the method reverts back to block 202.

In another exemplary embodiment, the determining, with the ADAS controller 52 in communication with the plurality of sensors 40a-40n within the vehicle 10, that automatic positioning of the steerable wheels 16, 18 of the vehicle 10 is appropriate at block 204 further includes, when, at block 212, the ADAS controller 52 has determined that automatic positioning of the steerable wheels 16, 18 of the vehicle 10 is appropriate based on preferences of the operator, and, when, at block 216, the ADAS controller 52 determines that the vehicle 10 is parked, moving to block 218, receiving, with an environment module 70 within the ADAS controller 52, from the plurality of sensors 40a-40n within the vehicle 10, data related to an incline angle 72 of the roadway surface 74 where the vehicle 10 is parked, and, moving to block 220, determining, with the environment module 70, if the incline angle 72 of the roadway surface 74 where the vehicle 10 is parked is greater than a predetermined threshold, and determining, with the ADAS controller 52, that automatic positioning of the steerable wheels 16, 18 of the vehicle 10 is appropriate when the incline angle 72 of the roadway surface 74 where the vehicle 10 is parked is greater than the predetermined threshold. If the incline angle 72 of the roadway surface 74 where the vehicle 10 is parked is not greater than the predetermined threshold for the incline angle 72, the method 200 moves from block 220 to block 214, wherein the method ends.

In another exemplary embodiment, the determining, with the ADAS controller 52 in communication with the plurality of sensors 40a-40n within the vehicle 10, that automatic positioning of the steerable wheels 16, 18 of the vehicle 10 is appropriate at block 204 further includes, when, at block 212, the ADAS controller 52 has determined that automatic positioning of the steerable wheels 16, 18 of the vehicle 10 is appropriate based on preferences of the operator, and, when, at block 216, the ADAS controller determines that the vehicle 10 is parked, and, when, at block 220, the incline angle 72 of the roadway surface 74 where the vehicle 10 is parked is greater than the predetermined threshold for the incline angle 72, moving to block 222, receiving, with the environment module 70, from the plurality of sensors 40a-40n within the vehicle 10, data related to a proximity of the vehicle 10 to a road edge 76 and/or curb 78, and calculating, with the environment module 70, a distance 80 between the vehicle 10 and the road edge 76 and/or curb 78, and, moving to block 224, determining, with the ADAS controller 52, that automatic positioning of the steerable wheels 16, 18 of the vehicle 10 is appropriate when the distance 80 between the vehicle 10 and the road edge 76 and/or curb 78 is less than a predetermined threshold for such distance 80.

In another exemplary embodiment, after the ADAS controller 52 determines that automatic positioning of the steerable wheels 16, 18 of the vehicle 10 is appropriate at block 204, the calculating, with the ADAS controller 52, the desired steering angle 82 for the steerable wheels 16, 18 of the vehicle 10 at block 206 further includes, moving to block 226, receiving, with the environment module 70, from the plurality of sensors 40a-40n within the vehicle 10, data related to presence of a curb 78 in proximity of the vehicle 10, and when a curb 78 is present, moving to block 228, calculating, with the environmental module 70, with data from the plurality of sensors 40a-40n, a height of the curb 78.

If at block 226, the ADAS controller 52 determines that no curb 78 is present, then the method moves to block 230, wherein the calculating, with the ADAS controller 52, the desired steering angle 82 for the steerable wheels 16, 18 of the vehicle 10 further includes calculating, with a hill parking module 84 of the ADAS controller 52, a desired roll-away trajectory 86 based on a location of the vehicle 10 relative to the road edge 76 and calculating, with the hill parking module 84, the desired steering angle 82 based on the desired roll-away trajectory 86.

If at block 226, the ADAS controller 52 determines that a curb 78 is present, then the method moves from block 228 to block 232, wherein when the height of the curb 78 is less than a pre-determined threshold, then the method moves to block 230, wherein the calculating, with the ADAS controller 52, the desired steering angle 82 for the steerable wheels 16, 18 of the vehicle 10 further includes calculating, with a hill parking module 84 of the ADAS controller 52, a desired roll-away trajectory 86 based on a location of the vehicle 10 relative to the road edge 76 and calculating, with the hill parking module 84, the desired steering angle 82 based on the desired roll-away trajectory 86.

If at block 232, the height of the curb 78 is at least the pre-determined threshold, then, moving to block 234, the method 200 includes calculating, with the hill parking module 84, the desired roll-away trajectory 86 based on a location of the vehicle 10 relative to the curb 78 and calculating the desired steering angle 82 to bring the steerable wheels 16, 18 into contact with the curb 78.

The method 200 moves from either block 230 or block 234 to block 208, wherein the steering rack motor 62 is actuated to begin, at block 210 positioning of the steerable wheels 16, 18 of the vehicle 10 at the desired steering angle 82.

In another exemplary embodiment, the positioning, with the steering rack motor 62, the steerable wheels 16, 18 of the vehicle 10 at the desired steering angle 82 further includes, moving to block 236, receiving, with the hill parking module 84, data from the plurality of sensors 40a-40n within the vehicle 10 related to the steering angle of the steerable wheels 16, 18 of the vehicle 10, determining, with the hill parking module 84, if the steerable wheels 16, 18 of the vehicle 10 have been moved to the desired steering angle 82, and, when the steerable wheels 16, 18 of the vehicle 10 have reached the desired steering angle 82, moving to block 238, deactivating positioning of the steerable wheels 16, 18 of the vehicle 10, and displaying, with a communication module 110 within the ADAS controller 52, via the HMI 64, a message 120 indicating that the automatic positioning of the steerable wheels 16, 18 of the vehicle 10 is complete.

In another exemplary embodiment, the positioning, with the steering rack motor 62, the steerable wheels 16, 18 of the vehicle 10 at the desired steering angle 82 at block 210 further includes, when, at block 236, the steerable wheels 16, 18 of the vehicle 10 have not yet reached the desired steering angle, moving to block 240, receiving, with the hill parking module 84, data from a steering rack torque sensor 60 related to an amount of torque being applied to the steerable wheels 16, 18 of the vehicle 10, determining, with the hill parking module 84, if the amount of torque being applied to the steerable wheels 16, 18 of the vehicle 10 exceeds a pre-determined threshold, and when the amount of torque being applied to the steerable wheels 16, 18 of the vehicle 10 exceeds the pre-determined threshold, moving to block 242, deactivating positioning of the steerable wheels 16, 18 of the vehicle 10, and displaying, with the communication module 110, via the HMI 64, a message 124 indicating that the automatic positioning of the steerable wheels 16, 18 of the vehicle 10 has been cancelled.

In another exemplary embodiment, the positioning, with the steering rack motor 62, the steerable wheels 16, 18 of the vehicle 10 at the desired steering angle 82 at block 210 further includes, when, at block 236, the steerable wheels 16, 18 of the vehicle 10 have not yet reached the desired steering angle 82, and, at block 240, the amount of torque being applied to the steerable wheels 16, 18 of the vehicle 10 does not exceed the pre-determined threshold, moving to block 244, receiving, with the hill parking module 84, data from a steering wheel torque sensor 58 related to an amount of torque being applied to a steering wheel by an operator of the vehicle 10, and determining, with the hill parking module 84, if the amount of torque being applied to the steering wheel exceeds a pre-determined threshold, and when the amount of torque being applied to the steering wheel exceeds the pre-determined threshold, moving to block 242, deactivating positioning of the steerable wheels 16, 18 of the vehicle 10, and displaying, with the communication module 110, via the HMI 64, a message 126 indicating that the automatic positioning of the steerable wheels 16, 18 of the vehicle 10 has been cancelled.

In another exemplary embodiment, the positioning, with the steering rack motor 62, the steerable wheels 16, 18 of the vehicle 10 at the desired steering angle 82 at block 210 further includes, when, at block 236, the steerable wheels 16, 18 of the vehicle 10 have not yet reached the desired steering angle 82, and, at block 240, the amount of torque being applied to the steerable wheels 16, 18 of the vehicle 10 does not exceed the pre-determined threshold, and, at block 244, the amount of torque being applied to the steering wheel does not exceed the pre-determined threshold, moving to block 246, the method 200 includes receiving, with the hill parking module 84, data from the gear selector sensor 56, determining, with the hill parking module 84, if the vehicle 10 has been shifted out of park, and, when the vehicle 10 has been shifted out of park, moving to block 242, deactivating positioning of the steerable wheels 16, 18 of the vehicle 10, and displaying, with the communication module 110, via the HMI 64, a message 128 indicating that the automatic positioning of the steerable wheels 16, 18 of the vehicle 10 has been cancelled.

If, at block 236, the steerable wheels 16, 18 of the vehicle 10 have not yet reached the desired steering angle 82, and, at block 240, the amount of torque being applied to the steerable wheels 16, 18 of the vehicle 10 does not exceed the pre-determined threshold, and, at block 244, the amount of torque being applied to the steering wheel does not exceed the pre-determined threshold, and, at block 246, the vehicle 10 has not been shifted out of park, the method 200 reverts back to block 208 and positioning of the steerable wheels 16, 18 at block 210 continues.

The method 200 moves from either block 238 or block 242 to block 214, wherein the method 200 ends.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of automatically positioning steerable wheels of a vehicle parked on an inclined surface, comprising:
determining, with an automatic driving assistance system (ADAS) controller in communication with a plurality of sensors within the vehicle, that automatic positioning of the steerable wheels of the vehicle is appropriate;
calculating, with the ADAS controller, a desired steering angle for the steerable wheels of the vehicle;
actuating, with the ADAS controller, a steering rack motor; and
positioning, with the steering rack motor, the steerable wheels of the vehicle at the desired steering angle.

2. The method of claim 1, wherein the determining, with the ADAS controller in communication with the plurality of sensors within the vehicle, that automatic positioning of the steerable wheels of the vehicle is appropriate further includes:
receiving, with an enablement module of the ADAS controller, from a human machine interface (HMI) within the vehicle, preferences from an operator within the vehicle; and
determining, with the ADAS controller, that automatic positioning of the steerable wheels of the vehicle is appropriate based on preferences of the operator.

3. The method of claim 2, wherein the determining, with the ADAS controller in communication with the plurality of sensors within the vehicle, that automatic positioning of the steerable wheels of the vehicle is appropriate further includes, when the ADAS controller has determined that automatic positioning of the steerable wheels of the vehicle is appropriate based on preferences of the operator:
determining, with the ADAS controller, that the vehicle is parked by:
receiving, with a parking detection module within the ADAS controller, from a gear selector sensor within the vehicle, data related to a state of a transmission of the vehicle;
receiving, with the parking detection module within the ADAS controller, from the plurality of sensors within the vehicle, data related to movement of the vehicle; and
determining, with the parking detection module, that the vehicle is parked when the transmission is in park and the vehicle is stopped; and
determining, with the ADAS controller, that automatic positioning of the steerable wheels of the vehicle is appropriate when the vehicle is parked.

4. The method of claim 3, wherein the determining, with the ADAS controller in communication with the plurality of sensors within the vehicle, that automatic positioning of the steerable wheels of the vehicle is appropriate further includes, when the ADAS controller has determined that automatic positioning of the steerable wheels of the vehicle is appropriate based on preferences of the operator and the vehicle is parked:
receiving, with an environment module within the ADAS controller, from the plurality of sensors within the vehicle, data related to an incline angle of the roadway surface where the vehicle is parked;
determining, with the environment module, if the incline angle of the roadway surface where the vehicle is parked is greater that a predetermined threshold; and
determining, with the ADAS controller, that automatic positioning of the steerable wheels of the vehicle is appropriate when the incline angle of the roadway surface where the vehicle is parked is greater than the predetermined threshold.

5. The method of claim 4, wherein the determining, with the ADAS controller in communication with the plurality of sensors within the vehicle, that automatic positioning of the steerable wheels of the vehicle is appropriate further includes, when the ADAS controller has determined that automatic positioning of the steerable wheels of the vehicle is appropriate based on preferences of the operator, the vehicle is parked, and the incline angle of the roadway surface where the vehicle is parked is greater than the predetermined threshold:
receiving, with the environment module, from the plurality of sensors within the vehicle, data related to a proximity of the vehicle to a road edge and/or curb;
calculating, with the environment module, a distance between the vehicle and the road edge and/or curb; and
determining, with the ADAS controller, that automatic positioning of the steerable wheels of the vehicle is appropriate when the distance between the vehicle and the road edge and/or curb is less than a predetermined threshold.

6. The method of claim 5, wherein, after the ADAS controller determines that automatic positioning of the steerable wheels of the vehicle is appropriate, the calculating, with the ADAS controller, the desired steering angle for the steerable wheels of the vehicle further includes:
receiving, with the environment module, from the plurality of sensors within the vehicle, data related to presence of a curb in proximity of the vehicle; and
when a curb is present, calculating, with the environmental module, with data from the plurality of sensors, a height of the curb.

7. The method of claim 7, wherein the calculating, with the ADAS controller, the desired steering angle for the steerable wheels of the vehicle further includes:
when no curb is present, calculating, with a hill parking module of the ADAS controller, a desired roll-away trajectory based on a location of the vehicle relative to the road edge and calculating, with the hill parking module, the desired steering angle based on the desired roll-away trajectory;
when the height of the curb is less than a pre-determined threshold, calculating, with the hill parking module, the roll-away trajectory and the desired steering angle the same as when no curb is present; and
when the height of the curb is at least the pre-determined threshold, calculating, with the hill parking module, the desired roll-away trajectory based on a location of the vehicle relative to the curb and calculating the desired steering angle to bring the steerable wheels into contact with the curb.

8. The method of claim 7, wherein, the positioning, with the steering rack motor, the steerable wheels of the vehicle at the desired steering angle further includes:
receiving, with the hill parking module, data from the plurality of sensors within the vehicle related to the steering angle of the steerable wheels of the vehicle;
determining, with the hill parking module, if the steerable wheels of the vehicle have been moved to the desired steering angle; and
when the steerable wheels of the vehicle have reached the desired steering angle:
deactivating positioning of the steerable wheels of the vehicle; and
displaying, with a communication module within the ADAS controller, via the HMI, a message indicating that the automatic positioning of the steerable wheels of the vehicle is complete.

9. The method of claim 8, wherein, the positioning, with the steering rack motor, the steerable wheels of the vehicle at the desired steering angle further includes, when the steerable wheels of the vehicle have not yet reached the desired steering angle:
receiving, with the hill parking module, data from a steering rack torque sensor related to an amount of torque being applied to the steerable wheels of the vehicle;
determining, with the hill parking module, if the amount of torque being applied to the steerable wheels of the vehicle exceeds a pre-determined threshold; and
when the amount of torque being applied to the steerable wheels of the vehicle exceeds the pre-determined threshold:
deactivating positioning of the steerable wheels of the vehicle; and
displaying, with the communication module, via the HMI, a message indicating that the automatic positioning of the steerable wheels of the vehicle has been cancelled.

10. The method of claim 9, wherein, the positioning, with the steering rack motor, the steerable wheels of the vehicle at the desired steering angle further includes, when the steerable wheels of the vehicle have not yet reached the desired steering angle and the amount of torque being applied to the steerable wheels of the vehicle does not exceed the pre-determined threshold:
receiving, with the hill parking module, data from a steering wheel torque sensor related to an amount of torque being applied to the steering wheel by an operator of the vehicle;
determining, with the hill parking module, if the amount of torque being applied to the steering wheel exceeds a pre-determined threshold; and
when the amount of torque being applied to the steering wheel exceeds the pre-determined threshold:
deactivating positioning of the steerable wheels of the vehicle; and
displaying, with the communication module, via the HMI, a message indicating that the automatic positioning of the steerable wheels of the vehicle has been cancelled.

11. The method of claim 10, wherein, the positioning, with the steering rack motor, the steerable wheels of the vehicle at the desired steering angle further includes, when the steerable wheels of the vehicle have not yet reached the desired steering angle, the amount of torque being applied to the steerable wheels of the vehicle does not exceed the pre-determined threshold, and the amount of torque being applied to the steering wheel does not exceed the pre-determined threshold:
receiving, with the hill parking module, data from the gear selector sensor;
determining, with the hill parking module, if the vehicle has been shifted out of park; and
when the vehicle has been shifted out of park:
deactivating positioning of the steerable wheels of the vehicle; and
displaying, with the communication module, via the HMI, a message indicating that the automatic positioning of the steerable wheels of the vehicle has been cancelled.

12. The method of claim 11, wherein the calculating, with the ADAS controller, the desired steering angle for the steerable wheels of the vehicle further includes minimizing an object function presented as:
$$J = {\sum }_{k = 1}^{N} ‖ ( y - {y}_{des} ) ‖ \begin{matrix}2 \\ Q\end{matrix} + ‖ u - {u}_{des} ‖ \begin{matrix}2 \\ R\end{matrix} + ‖ u - {u}_{fn 1} ‖ \begin{matrix}2 \\ F\end{matrix} ;$$
Wherein, u_{fnl} represents the desired steering angle.

13. A system for automatically positioning steerable wheels of a vehicle parked on an inclined surface, comprising:
an automatic driving assistance system (ADAS) controller in communication with a plurality of sensors and adapted to:
determine that automatic positioning of the steerable wheels of the vehicle is appropriate;
calculate a desired steering angle for the steerable wheels of the vehicle;
actuate a steering rack motor; and
position, with the steering rack motor, the steerable wheels of the vehicle at the desired steering angle.

14. The system of claim 13, wherein when determining that automatic positioning of the steerable wheels of the vehicle is appropriate, the ADAS controller is further adapted to:
receive, with an enablement module of the ADAS controller, from a human machine interface (HMI) within the vehicle, preferences from an operator within the vehicle; and
determine that automatic positioning of the steerable wheels of the vehicle is appropriate based on preferences of the operator.

15. The system of claim 14, wherein when the ADAS controller has determined that automatic positioning of the steerable wheels of the vehicle is appropriate based on preferences of the operator, the ADAS controller is further adapted to:
receive, with a parking detection module within the ADAS controller, from a gear selector sensor within the vehicle, data related to a state of a transmission of the vehicle;
receive, with the parking detection module, from the plurality of sensors within the vehicle, data related to movement of the vehicle;
determine, with the parking detection module, that the vehicle is parked when the transmission is in park and the vehicle is stopped; and
determine that automatic positioning of the steerable wheels of the vehicle is appropriate when the vehicle is parked.

16. The system of claim 15, wherein when the ADAS controller has determined that automatic positioning of the steerable wheels of the vehicle is appropriate based on preferences of the operator and the vehicle is parked, the ADAS controller is further adapted to:
receive, with an environment module within the ADAS controller, from the plurality of sensors within the vehicle, data related to an incline angle of the roadway surface where the vehicle is parked;
determine, with the environment module, if the incline angle of the roadway surface where the vehicle is parked is greater that a predetermined threshold; and
determine that automatic positioning of the steerable wheels of the vehicle is appropriate when the incline angle of the roadway surface where the vehicle is parked is greater than the predetermined threshold.

17. The system of claim 16, wherein when the ADAS controller has determined that automatic positioning of the steerable wheels of the vehicle is appropriate based on preferences of the operator, the vehicle is parked, and the incline angle of the roadway surface where the vehicle is parked is greater than the predetermined threshold, the ADAS controller is further adapted to:
receive, with the environment module, from the plurality of sensors within the vehicle, data related to a proximity of the vehicle to a road edge and/or curb;
calculate, with the environment module, a distance between the vehicle and the road edge and/or curb; and
determine that automatic positioning of the steerable wheels of the vehicle is appropriate when the distance between the vehicle and the road edge and/or curb is less than a predetermined threshold.

18. The system of claim 17, wherein the ADAS controller is further adapted to one of:
when no curb is present, calculate, with a hill parking module of the ADAS controller, a desired roll-away trajectory based on a location of the vehicle relative to the road edge and calculate, with the hill parking module, the desired steering angle based on the desired roll-away trajectory;
when a curb is present and a height of the curb is less than a pre-determined threshold, calculate, with the hill parking module, the roll-away trajectory and the desired steering angle the same as when no curb is present; or
when a curb is present and a height of the curb is at least the pre-determined threshold, calculate, with the hill parking module, the desired roll-away trajectory based on a location of the vehicle relative to the curb and calculating the desired steering angle to bring the steerable wheels into contact with the curb.

19. The system of claim 18, wherein, when positioning with the steering rack motor, the steerable wheels of the vehicle at the desired steering angle, the ADAS controller is further adapted to:
deactivate positioning of the steerable wheels of the vehicle and display, with a communication module within the ADAS controller, via the HMI, a message indicating that the automatic positioning of the steerable wheels of the vehicle is complete when the steering angle of the steerable wheels of the vehicle, measured by a steering angle sensor, reaches the desired steering angle; and
deactivate positioning of the steerable wheels of the vehicle, and display, with the communication module, via the HMI, a message indicating that the automatic positioning of the steerable wheels of the vehicle has been cancelled when at least one of:
the steerable wheels of the vehicle have not yet reached the desired steering angle and an amount of torque being applied to the steerable wheels of the vehicle, measured by a steering rack torque sensor, exceeds a pre-determined threshold;
the steerable wheels of the vehicle have not yet reached the desired steering angle, the amount of torque being applied to the steerable wheels of the vehicle does not exceed the pre-determined threshold, and an amount of torque being applied to the steering wheel by an operator within the vehicle, measured by a steering wheel torque sensor, exceeds a pre-determined threshold; and
the steerable wheels of the vehicle have not yet reached the desired steering angle, the amount of torque being applied to the steerable wheels of the vehicle does not exceed the pre-determined threshold, the amount of torque being applied to the steering wheel does not exceed the pre-determined threshold, and the vehicle has been shifted out of park.

20. A vehicle having a system for automatically positioning steerable wheels of a vehicle parked on an inclined surface, the system comprising:
an automatic driving assistance system (ADAS) controller in communication with a plurality of sensors, having an enablement module, a parking detection module, an environment module, a hill parking module and a communication module and adapted to:
determine that automatic positioning of the steerable wheels of the vehicle is appropriate based on:
preferences of the operator received by the enablement module from a human machine interface (HMI) of the communication module;
the vehicle is parked based on determination by the parking detection module that the vehicle is not moving and a transmission of the vehicle is in park;
an incline angle of the roadway surface where the vehicle is parked, calculated by the environment module, is greater that a predetermined threshold; and
a distance between the vehicle and a road edge and/or curb, calculated by the environment module, is less than a predetermined threshold;
calculate a desired steering angle for the steerable wheels of the vehicle by one of:
when no curb is present, calculate, with a hill parking module of the ADAS controller, a desired roll-away trajectory based on a location of the vehicle relative to the road edge and calculate, with the hill parking module, the desired steering angle based on the desired roll-away trajectory;
when a curb is present and a height of the curb is less than a pre-determined threshold, calculate, with the hill parking module, the roll-away trajectory and the desired steering angle the same as when no curb is present; or
when a curb is present and a height of the curb is at least the pre-determined threshold, calculate, with the hill parking module, the desired roll-away trajectory based on a location of the vehicle relative to the curb and calculating the desired steering angle to bring the steerable wheels into contact with the curb;
actuate a steering rack motor;
position, with the steering rack motor, the steerable wheels of the vehicle at the desired steering angle;
deactivate positioning of the steerable wheels of the vehicle and display, with a communication module within the ADAS controller, via the HMI, a message indicating that the automatic positioning of the steerable wheels of the vehicle is complete when the steering angle of the steerable wheels of the vehicle, measured by a steering angle sensor, reaches the desired steering angle; and
deactivate positioning of the steerable wheels of the vehicle, and display, with the communication module, via the HMI, a message indicating that the automatic positioning of the steerable wheels of the vehicle has been cancelled when at least one of:
the steerable wheels of the vehicle have not yet reached the desired steering angle and an amount of torque being applied to the steerable wheels of the vehicle, measured by a steering rack torque sensor, exceeds a pre-determined threshold;
the steerable wheels of the vehicle have not yet reached the desired steering angle, the amount of torque being applied to the steerable wheels of the vehicle does not exceed the pre-determined threshold, and an amount of torque being applied to the steering wheel by an operator within the vehicle, measured by a steering wheel torque sensor, exceeds a pre-determined threshold; and
the steerable wheels of the vehicle have not yet reached the desired steering angle, the amount of torque being applied to the steerable wheels of the vehicle does not exceed the pre-determined threshold, the amount of torque being applied to the steering wheel does not exceed the pre-determined threshold, and the vehicle has been shifted out of park.
